(19) United States
(12) Patent Application Publication
(10) Pub. No.: US 2023/0313834 A1
(43) Pub. Date: Oct. 5, 2023

(54) TORQUE PERFORMANCE BEARINGS AND METHODS OF MAKING AND USING THE SAME

(71) Applicant: Saint-Gobain Performance Plastics Corporation, Solon, OH (US)

(72) Inventors: Jian MA, Shanghai (CN); Xiaoye Liu, Shanghai (CN); Timothy J. Hagan, Succasunna, NJ (US); Johanna Merluza, Fair Lawn, NJ (US); Feng Shi, Shanghai (CN); Michael Adrian Danyluk, New City, NY (US); Florian Foerster, Duisburg (DE)

(21) Appl. No.: 18/194,188

(22) Filed: Mar. 31, 2023

Related U.S. Application Data
(60) Provisional application No. 63/362,349, filed on Apr. 1, 2022.

(51) Int. Cl. F16C 17/12; F16C 33/30

(52) U.S. Cl. CPC F16C 17/12; F16C 33/30

(57) ABSTRACT

A bearing including: a sidewall including a substrate and a low friction layer overlying the substrate, where the sidewall further includes: an unformed section; at least one slot in the unformed section; and at least one protrusion extending from the unformed section forming a generally concave or convex cross-sectional shape in the sidewall.

### CROSS-REFERENCE TO RELATED APPLICATION(S)

This application claims priority under 35 U.S.C. § 119(e) to U.S. Provisional Application No. 63/362,349, entitled “TORQUE PERFORMANCE BEARINGS AND METHODS OF MAKING AND USING THE SAME,” by Jian M A et al., filed Apr. 1, 2022, which is assigned to the current assignee hereof and incorporated herein by reference in its entirety.

### FIELD OF THE DISCLOSURE

This disclosure generally relates to bearings and, in particular, to bearings having defined torque or linear sliding performance.

### BACKGROUND

Commonly, bearings constrain relative movement to the desired motion and reduce friction between moving parts. One type of bearing may be located in a gap between the outer surface of an inner component and the inner surface of the bore of an outer component within an assembly. Exemplary assemblies may include door, hood, tailgate, engine compartment hinges, seats, steering columns, flywheels, driveshaft assemblies, friction brakes, spindle drives, or may include other assemblies, notably those used in automotive applications. Sometimes, there exists a need to have a tailored torque fluctuation across components such as the inner component (such as a shaft) and the outer component (such as a housing) in such an assembly. Such torque fluctuation may cause sizing issues, hardness, noise, and undesired wear over the lifetime of the assembly. Further, in specific friction brake or spindle drive assemblies for vehicle doors, low fluctuation of frictional torque performance may be important to stop the door at any position and compensate spring force for more reliable safety control. Therefore, there exists an ongoing need for improved bearings that provide improved torque performance while maintaining a longer lifetime of the assembly.

### SUMMARY

Embodiments of the invention may include: a bearing, including: a sidewall including a substrate and a low friction layer overlying the substrate, where the sidewall further includes: an unformed section; at least one slot in the unformed section; and at least one protrusion extending from the unformed section forming a generally concave cross-sectional shape in the sidewall.

Embodiments of the invention may include: a bearing, including: a sidewall including a substrate and a low friction layer overlying the substrate, where the sidewall further includes: an unformed section; at least one slot in the unformed section; and at least one protrusion extending from the unformed section forming a generally convex cross-sectional shape in the sidewall.

Embodiments of the invention may include: an assembly, including: an outer component including a bore within the outer component; an inner component disposed within the bore; and a bearing disposed between the inner component and the outer component, the bearing including: a sidewall including a substrate and a low friction layer overlying the substrate, where the sidewall further includes: an unformed section; at least one slot in the unformed section; and at least one protrusion extending from the unformed section forming a generally concave or convex cross-sectional shape in the sidewall.

Embodiments of the invention may include: an assembly, including: an outer component including a bore within the outer component; an inner component disposed within the bore; and a bearing disposed between the inner component and the outer component and fixed to the outer component, the bearing including: a sidewall including a substrate and a low friction layer overlying the substrate, where the sidewall further includes: an unformed section; at least one slot in the unformed section; and at least one protrusion extending from the unformed section forming a generally concave or convex cross-sectional shape in the sidewall, where the bearing has a frictional torque with the inner or outer component, where a frictional torque variation of the assembly over a lifetime of at least 1 million cycles and a temperature range of −40° C. to 80° C. is within ±20%.

Embodiments of the invention may include: a method, including: positioning a bearing between the inner component and the outer component, the bearing including: a sidewall including a substrate and a low friction layer overlying the substrate, where the sidewall further includes: an unformed section; at least one slot in the unformed section; and at least one protrusion extending from the unformed section, and a generally concave or convex cross-sectional shape in the sidewall.

Embodiments of the invention may include: a method, including: positioning a bearing between the inner component and the outer component, the bearing including: a sidewall including a substrate and a low friction layer overlying the substrate, where the sidewall further includes: an unformed section; at least one slot in the unformed section; and at least one protrusion extending from the unformed section forming a generally concave or convex cross-sectional shape in the sidewall; and rotating or translating the bearing to form a frictional torque with the inner or outer component, where a frictional torque variation of the assembly over a lifetime of at least 1 million cycles and a temperature range of −40° C. to 80° C. is within ±20%.

### BRIEF DESCRIPTION OF THE DRAWINGS

The present disclosure may be better understood, and its numerous features and advantages made apparent to those skilled in the art by referencing the accompanying drawings.

FIG. 1 includes a method of producing a bearing in accordance with an embodiment;

FIG. 2A includes a cross-sectional view of one embodiment of a bearing material for a bearing in accordance with an embodiment;

FIG. 2B includes a cross-sectional view of one embodiment of a bearing material for a bearing in accordance with an embodiment;

FIG. 2C includes a cross-sectional view of one embodiment of a bearing material for a bearing in accordance with an embodiment;

FIG. 3A is a diagrammatic view showing the shape line of the surface of a low friction material for a bearing according to the embodiment;

FIG. 3B is a diagrammatic view showing a simplified version of the shape line shown in FIG. 3A for the sake of illustration;

FIG. 3C is a diagrammatic view showing straight lines that connect the bottoms of recesses and the apexes of protrusions to each other along the shape line shown in FIG. 3A;

FIG. 4A includes a perspective view of a bearing constructed in accordance with an embodiment;

FIG. 4B includes a perspective view of a bearing constructed in accordance with an embodiment;

FIG. 4C includes a perspective view of a bearing constructed in accordance with an embodiment;

FIG. 4D includes a perspective view of a bearing constructed in accordance with an embodiment;

FIG. 4E includes a perspective view of a bearing constructed in accordance with an embodiment;

FIG. 4F includes a perspective view of a bearing constructed in accordance with an embodiment;

FIG. 4G includes a perspective view of a bearing constructed in accordance with an embodiment;

FIG. 4H includes a perspective view of a bearing constructed in accordance with an embodiment;

FIG. 5A includes an axial sectional view of the bearing of FIG. 4 in an assembly in accordance with an embodiment;

FIG. 5B includes a radial sectional view of the bearing of FIG. 3 in the assembly in accordance with an embodiment;

FIG. 6 includes a method using a bearing in accordance with an embodiment;

FIG. 7 includes a graph of a frictional torque curve vs. test cycles of a bearing in accordance with an embodiment; and

FIG. 8 includes a graph of a normalized torque curve vs. temperature of a bearing with shaft samples of differing surface roughness in accordance with an embodiment;

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention. The use of the same reference symbols in different drawings indicates similar or identical items.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or assembly that comprises a list of features is not necessarily limited only to those features but may include other features not expressly listed or inherent to such method, article, or assembly. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single embodiment is described herein, more than one embodiment may be used in place of a single embodiment. Similarly, where more than one embodiment is described herein, a single embodiment may be substituted for that more than one embodiment.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the bearing and bearing assembly arts.

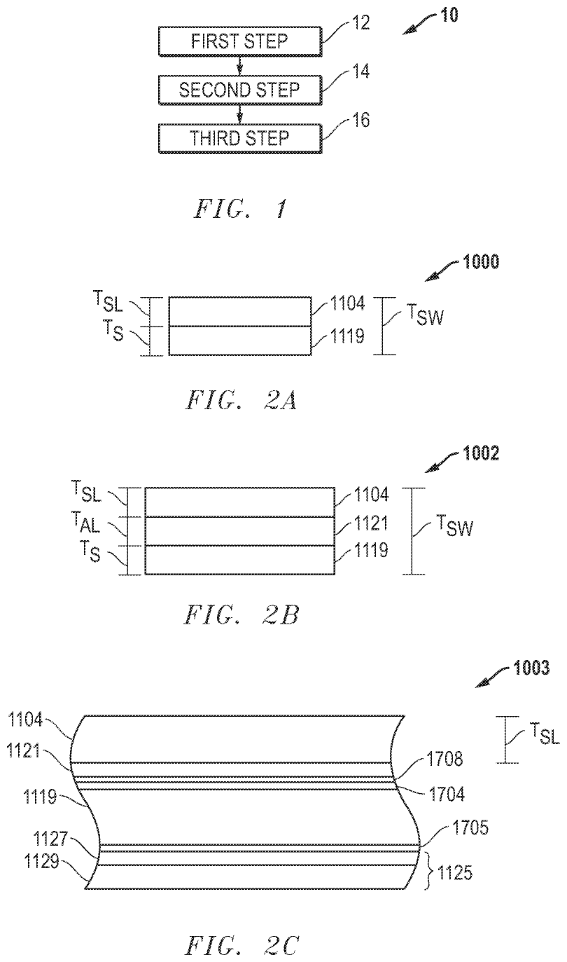

For purposes of illustration, FIG. 1 includes a method of producing a low friction material in accordance with embodiments described above. The forming process 10 may include a first step 12 of providing a base material, a second step 14 of coating the base material with a low friction coating to form a low friction material, and a third step 16 of forming the low friction material into a bearing.

Referring to the first step 12, the base material may be a substrate. In an embodiment, the substrate can at least partially include a metal, plastic, or ceramic. In an embodiment, the substrate can at least partially include a metal. According to certain embodiments, the metal may include iron, bronze, magnesium, zinc, copper, titanium, tin, aluminum, alloys thereof, or may be another type of material. More particularly, the substrate can at least partially include a steel, such as, a stainless steel, carbon steel, or spring steel. For example, the substrate can at least partially include a 301 stainless steel. The 301 stainless steel may be annealed, ¼ hard, ½ hard, ¾ hard, or full hard. Moreover, the steel can include stainless steel including chrome, nickel, or a combination thereof. A particular stainless steel is 301 stainless steel. The base material and/or substrate can be of any structure or shape. In embodiments, the base material and/or substrate can be a plate, a sheet, a woven fabric, a mesh, a grid, an expended sheet, a perforated sheet, or metal foam or combination thereof. For example, in some embodiments, the substrate may include a plate and a woven fabric. In other embodiments, the substrate may include a metal plate and a different metal overlying the metal plate. The substrate may include a woven mesh or an expanded metal grid, an expanded sheet, or a perforated sheet. Alternatively, the woven mesh can be a woven polymer mesh. In an alternate embodiment, the substrate may not include a mesh or grid.

In a number of embodiments, the substrate may be spring steel. The spring steel substrate may be annealed, ¼ hard, ½ hard, ¾ hard, or full hard. The spring steel substrate may have a tensile strength of not less than 600 MPa, such as not less than 700 MPa, such as not less than 750 MPa, such as not less than 800 MPa, such as not less than 900 MPa, or such as not less than 1000 MPa. The spring steel substrate may have a tensile strength of no greater than 1500 MPa, or such as no greater than 1250 MPa.

In other embodiments, the substrate can have a coating. The coating can be a layer of another metal or alloy. In embodiments, the coating may be a metal or alloy containing at least one of the following metals: chromium, molybdenum, tungsten, manganese, iron, ruthenium, osmium, cobalt, rhodium, iridium, nickel, palladium, platinum, copper, silver, gold, zinc, cadmium, mercury, aluminum, gallium, indium, thallium, silicon, germanium, tin, lead, antimony, and bismuth. In yet other embodiments, the coating can be a copper alloy, a copper-tin alloy, a copper-zinc alloy, a bronze, a phosphor bronze, a silicon bronze, a brass, or any combinations thereof.

FIG. 2A includes an illustration of the low friction material or composite material 1000 that may be formed according to first step 12 and second step 14 of the forming process 10 for forming a low friction material for a bearing according to embodiments described above. For purposes of illustration, FIG. 2A shows the layer by layer configuration of a low friction material 1000 after second step 14. In a number of embodiments, the low friction material 1000 may include a substrate 1119 (i.e., the base material provided in the first step 12) and a low friction layer 1104 (i.e., the low friction coating applied in second step 14). As shown in FIG. 2A, the low friction layer 1104 can be coupled to at least a portion of the substrate 1119. In a particular embodiment, the low friction layer 1104 can be coupled to a surface of the substrate 1119 so as to form a low friction interface with another surface of another component. The low friction layer 1104 can be coupled to the radially inner surface of the substrate 1119 so as to form a low friction interface with another surface of another component. The low friction layer 1104 can be coupled to the radially outer surface of the substrate 1119 so as to form a low friction interface with another surface of another component. In another embodiment, the substrate 1119 may be embedded within the low friction layer 1104 so as to provide low friction layer 1104 on both sides of the substrate 1119.

The low friction layer may be textured, as discussed in more detail below. In a number of embodiments, the low friction layer 1104 can include a low friction material. Low friction materials may include, for example, for example, a polymer, such as a polyketone, a polyaramid, a polyimide, a polyetherimide, a polyphenylene sulfide, a polyethersulfone, a polysulfone, a polyphenylene sulfone, a polyamideimide, ultra high molecular weight polyethylene, a fluoropolymer, a polyamide, a polybenzimidazole, or any combination thereof. In an example, the low friction layer 1104 includes a polyketone, a polyaramid, a polyimide, a polyetherimide, a polyamideimide, a polyphenylene sulfide, a polyphenylene sulfone, a fluoropolymer, a polybenzimidazole, a derivative thereof, or a combination thereof. In a particular example, the low friction/wear resistant layer includes a polymer, such as a polyketone, a thermoplastic polyimide, a polyetherimide, a polyphenylene sulfide, a polyether sulfone, a polysulfone, a polyamideimide, a derivative thereof, or a combination thereof. In a further example, the low friction/wear resistant layer includes polyketone, such as polyether ether ketone (PEEK), polyether ketone, polyether ketone ketone, polyether ketone ether ketone, a derivative thereof, or a combination thereof. In an additional example, the low friction/wear resistant layer may be an ultra high molecular weight polyethylene. An example fluoropolymer includes fluorinated ethylene propylene (FEP), polytetrafluoroethylene (PTFE), polyvinylidene fluoride (PVDF), perfluoroalkoxy (PFA), a terpolymer of tetrafluoroethylene, hexafluoropropylene, and vinylidene fluoride (THV), polychlorotrifluoroethylene (PCTFE), ethylene tetrafluoroethylene copolymer (ETFE), ethylene chlorotrifluoroethylene copolymer (ECTFE), polyacetal, polybutylene terephthalate (PBT), polyethylene terephthalate (PET), polyimide (PI), polyetherimide, polyetheretherketone (PEEK), polyethylene (PE), polysulfone, polyamide (PA), polyphenylene oxide, polyphenylene sulfide (PPS), polyurethane, polyester, liquid crystal polymers (LCP), or any combination thereof. The low friction layer 1104 may include a solid based material including lithium soap, graphite, boron nitride, molybdenum disulfide, tungsten disulfide, polytetrafluoroethylene, carbon nitride, tungsten carbide, or diamond like carbon, a metal (such as aluminum, zinc, copper, magnesium, tin, platinum, titanium, tungsten, lead, iron, bronze, steel, spring steel, stainless steel), a metal alloy (including the metals listed), an anodized metal (including the metals listed) or any combination thereof. Fluoropolymers may be used according to particular embodiments. In an embodiment, the low friction layer 1104 may not include polytetrafluoroethylene (PTFE).

In a number of embodiments, the low friction layer 1104 may further include fillers, including glass fibers, carbon fibers, silicon, PEEK, aromatic polyester, carbon particles, bronze, fluoropolymers, thermoplastic fillers, aluminum oxide, polyamideimide (PAI), PPS, polyphenylene sulfone (PPSO2), LCP, aromatic polyesters, molybdenum disulfide, tungsten disulfide, graphite, grapheme, expanded graphite, boron nitride, talc, calcium fluoride, or any combination thereof. Additionally, the filler can include alumina, silica, titanium dioxide, calcium fluoride, boron nitride, mica, Wollastonite, silicon carbide, silicon nitride, barium sulfate, zirconia, carbon black, pigments, or any combination thereof. In certain embodiments, the low friction layer 1104 may include an organic filler including polytetrafluoroethylene (PTFE), a polyamide (PA), a polyether ether ketone (PEEK), a polyimide (PI), a polyamideimide (PAI), a polyphenylene sulfide (PPS), a polyphenylene sulphone (PPSO2), a liquid crystal polymers (LCP), perfluoroalkoxypolymer (PFA), polyoxymethylene (POM), polyethylene (PE), UHMWPE, ethylene propylene diene, or a mixture thereof. In an embodiment, the low friction layer 1104 may include polytetrafluoroethylene (PTFE) only as a filler. Fillers can be in the form of beads, fibers, powder, mesh, or any combination thereof. The fillers may be at least 1 wt % based on the total weight of the low friction layer, such as at least 5 wt %, or even 10 wt % based on the total weight of the low friction layer.

The substrate 1119 can have a thickness Ts of at least about 0.05 mm, such as at least about 0.1 mm, at least about 0.15 mm, at least about 0.2 mm, at least about 0.25 mm, at least about 0.3 mm, at least about 0.35 mm, at least about 0.4 mm, or at least about 0.45 mm. The substrate 1119 can have a thickness Ts of not greater than about 5 mm, not greater than about 4 mm, not greater than about 3 mm, not greater than about 2.5 mm, not greater than about 2 mm, not greater than about 1.5 mm, not greater than about 1 mm, not greater than about 0.9 mm, not greater than about 0.8 mm, not greater than about 0.7 mm, not greater than about 0.6 mm, not greater than about 0.55 mm, or not greater than about 0.5 mm. It will be further appreciated that the thickness Ts of the substrate 1119 may be any value between any of the minimum and maximum values noted above. The thickness of the substrate 1119 may be uniform, i.e., a thickness at a first location of the substrate 1119 can be equal to a thickness at a second location therealong. The thickness of the substrate 1119 may be non-uniform, i.e., a thickness at a first location of the substrate 1119 can be different from a thickness at a second location therealong.

The low friction layer 1104 can have a thickness T_{SL} of at least about 0.05 mm, such as at least about 0.1 mm, at least about 0.15 mm, at least about 0.2 mm, at least about 0.25 mm, at least about 0.3 mm, at least about 0.35 mm, at least about 0.4 mm, or at least about 0.45 mm. The low friction layer 1104 can have a thickness T_{SL} of not greater than about 5 mm, not greater than about 4 mm, not greater than about 3 mm, not greater than about 2.5 mm, not greater than about 2 mm, not greater than about 1.5 mm, not greater than about 1 mm, not greater than about 0.9 mm, not greater than about 0.8 mm, not greater than about 0.7 mm, not greater than about 0.6 mm, not greater than about 0.55 mm, or not greater than about 0.5 mm. It will be further appreciated that the thickness T_{SL} of the low friction layer 1104 may be any value between any of the minimum and maximum values noted above. The thickness of the low friction layer 1104 may be uniform, i.e., a thickness at a first location of the low friction layer 1104 can be equal to a thickness at a second location therealong. The thickness of the low friction layer 1104 may be non-uniform, i.e., a thickness at a first location of the low friction layer 1104 can be different from a thickness at a second location therealong. It can be appreciated that different low friction layers 1104 may have different thicknesses. The low friction layer 1104 may overlie one major surface of the substrate 1119, shown, or overlie both major surfaces. The substrate 1119 may be at least partially encapsulated by the low friction layer 1104. That is, the low friction layer 1104 may cover at least a portion of the substrate 1119. Axial surfaces of the substrate 1119 may be exposed from the low friction layer 1104.

FIG. 2B includes an illustration of an alternative embodiment of the low friction material or composite material that may be formed according to first step 12 and second step 14 of the forming process 10 for forming a low friction material for a bearing according to embodiments described above. For purposes of illustration, FIG. 2B shows the layer by layer configuration of a low friction material 1002 after second step 14. According to this particular embodiment, the low friction material 1002 may be similar to the composite material 1000 of FIG. 2A, except this low friction material 1002 may also include at least one adhesive layer 1121 that may couple the low friction layer 1104 to the substrate 1119 (i.e., the base material provided in the first step 12) and a low friction layer 1104 (i.e., the low friction coating applied in second step 14). In another alternate embodiment, the substrate 1119, as a solid component, woven mesh or expanded metal grid, may be embedded between at least one adhesive layer 1121 included between the low friction layer 1104 and the substrate 1119.

The adhesive layer 1121 may include any known adhesive material common to the bearing arts including, but not limited to, fluoropolymers, epoxy resins, polyimide resins, polyether/polyamide copolymers, ethylene vinyl acetates, ethylene tetrafluoroethylene (ETFE), ETFE copolymer, perfluoroalkoxy (PFA), or any combination thereof. Additionally, the adhesive can include at least one functional group selected from —C═O, —C—O—R, —COH, —COOH, —COOR, —CF₂═CF—OR, or any combination thereof, where R is a cyclic or linear organic group containing between 1 and 20 carbon atoms. Additionally, the adhesive can include a copolymer. In an embodiment, the hot melt adhesive can have a melting temperature of not greater than 250° C., such as not greater than 220° C. In another embodiment, the adhesive may break down above 200° C., such as above 220° C. In further embodiments, the melting temperature of the hot melt adhesive can be higher than 250° C. or even higher than 300° C. The adhesive layer 1121 can have a thickness of about 1 to 50 microns, such as about 7 to 15 microns. In an embodiment, the hot melt adhesive can have a melting temperature of not greater than 250° C., such as not greater than 220° C. In another embodiment, the adhesive may break down above 200° C., such as above 220° C. In further embodiments, the melting temperature of the hot melt adhesive can be higher than 250° C. or even higher than 300° C.

The adhesive layer 1121 can have a thickness T_{AL} of between about 1 micron to about 80 microns, such as between about 10 microns and about 50 microns, such as between about 20 microns and about 40 microns. In a number of embodiments, the adhesive layer 1121 may have a thickness T_{AL} of between about 3 and 20 microns. In a number of embodiments, the adhesive layer 1121 may have a thickness T_{AL} of between about 10 and 60 microns. It will be further appreciated that the thickness T_{AL} of the adhesive layer 1121 may be any value between any of the minimum and maximum values noted above. The thickness of the adhesive layer 1121 may be uniform, i.e., a thickness at a first location of the adhesive layer 1121 can be equal to a thickness at a second location therealong. The thickness of the adhesive layer 1121 may be non-uniform, i.e., a thickness at a first location of the adhesive layer 1121 can be different from a thickness at a second location therealong.

The thickness of the adhesive layer 1121 can correspond essentially to the roughness of the substrate 1119, defined as the distance Rmax between the maximum profile apex height and the maximum profile nadir depth of the roughness profile of the surface of the substrate 1119. In this way, it can be ensured that a sufficiently thick adhesive layer 1121 is applied to the substrate 1119 so that a full-area adhesive bond between low friction layer 1104 and substrate 1119 is ensured. The adhesive layer 1121 should also not be made too thick. In this case, there would be a risk that, on joining the layers, parts of the adhesive layer 1121 could be pressed out from the adhesive bond or cohesive rupture could occur within parts of the adhesive layer 1121 projecting above the roughness profile of the substrate 1119 surface when the low friction material is subjected to shear stress.

For example, surface roughness of the substrate 1119 can be at least about 0.01 micron, at least about 0.02 micron, at least about 0.05 micron, at least about 0.1 micron, at least about 0.5 micron, at least about 1 micron, at least about 2 microns, at least about 5 microns, at least about 10 microns, at least about 20 microns, at least about 50 microns, at least about 100 microns, at least about 200 microns, or at least about 400 microns. In other embodiments, the surface roughness can be less than about 400 microns, less than about 200 microns, less than about 100 microns, less than about 50 microns, less than about 25 microns, less than about 20 microns, less than about 15 microns, less than about 10 microns, less than about 5 microns, less than about 3 microns, less than about 2 microns, or even less than about 1 micron. In yet another embodiment, the substrate 1119 can have a surface roughness in the range from about 0.1 micron to about 400 microns, from about 0.5 micron to about 100 microns, or from about 1 micron to about 50 microns.

Further, the surface of the substrate 1119 can be treated by electrolytic zinc-plating to roughen, upgrade, or coat the surface. This is done before application of the adhesive layer 1121. In other embodiments, the surface area of the substrate 1119 can be increased by mechanical structuring. The structuring can include brush-finishing, sand-blasting, etching, perforating, pickling, punching, pressing, curling, deep drawing, decambering, incremental sheet forming, ironing, laser cutting, rolling, hammering, embossing, undercutting, and any combinations thereof. For example, embossing of a structure allows for the possibility of intermeshing, which has a positive effect on the resulting bonding forces.

FIG. 2C includes an illustration of an alternative embodiment of the low friction material or composite material that may be formed according to first step 12 and second step 14 of the forming process 10 for forming a low friction material for a bearing according to embodiments described above. For purposes of illustration, FIG. 2C shows the layer by layer configuration of a low friction material 1003 after second step 14. According to this particular embodiment, the low friction material 1003 may be similar to the low friction material 1002 of FIG. 2B, except this low friction material 1003 may also include at least one corrosion protection layer 1704, 1705, and 1708, and a corrosion resistant coating 1125 that can include an adhesion promoter layer 1127 and an epoxy layer 1129 that may couple to the substrate 1119 (i.e., the base material provided in the first step 12) and a low friction layer 1104 (i.e., the low friction coating applied in second step 14).

The substrate 1119 may be coated with corrosion protection layers 1704 and 1705 to prevent corrosion of the low friction material 1003 prior to processing. Additionally, a corrosion protection layer 1708 can be applied over layer 1704. Each of layers 1704, 1705, and 1708 can have a thickness of about 1 to 50 microns, such as about 7 to 15 microns. Layers 1704 and 1705 can include a phosphate of zinc, iron, manganese, or any combination thereof, or a nano-ceramic layer. Further, layers 1704 and 1705 can include functional silanes, nano-scaled silane based primers, hydrolyzed silanes, organosilane adhesion promoters, solvent/water based silane primers, chlorinated polyolefins, passivated surfaces, commercially available zinc (mechanical/galvanic) or zinc-nickel coatings, or any combination thereof. Layer 1708 can include functional silanes, nano-scaled silane based primers, hydrolyzed silanes, organosilane adhesion promoters, solvent/water based silane primers. Corrosion protection layers 1704, 1705, and 1708 can be removed or retained during processing.

The low friction material 1003 may further include a corrosion resistant coating 1125. The corrosion resistant coating 1125 can have a thickness of about 1 to 50 microns, such as about 5 to 20 microns, and such as about 7 to 15 microns. The corrosion resistant coating 1125 can include an adhesion promoter layer 1127 and an epoxy layer 1129. The adhesion promoter layer 1127 can include a phosphate of zinc, iron, manganese, tin, or any combination thereof, or a nano-ceramic layer. The adhesion promoter layer 1127 can include functional silanes, nano-scaled silane based layers, hydrolyzed silanes, organosilane adhesion promoters, solvent/water based silane primers, chlorinated polyolefins, passivated surfaces, commercially available zinc (mechanical/galvanic) or Zinc-Nickel coatings, or any combination thereof. The epoxy layer 1129 can be a thermal cured epoxy, a UV cured epoxy, an IR cured epoxy, an electron beam cured epoxy, a radiation cured epoxy, or an air cured epoxy. Further, the epoxy layer 1129 can include polyglycidylether, diglycidylether, bisphenol A, bisphenol F, oxirane, oxacyclopropane, ethyleneoxide, 1,2-epoxypropane, 2-methyloxirane, 9,10-epoxy-9,10-dihydroanthracene, or any combination thereof. The epoxy layer 1129 can further include a hardening agent. The hardening agent can include amines, acid anhydrides, phenol novolac hardeners such as phenol novolac poly[N-(4-hydroxyphenyl)maleimide] (PHPMI), resole phenol formaldehydes, fatty amine compounds, polycarbonic anhydrides, polyacrylate, isocyanates, encapsulated polyisocyanates, boron trifluoride amine complexes, chromic-based hardeners, polyamides, or any combination thereof. Generally, acid anhydrides can conform to the formula R—C═O—O—C═O—R′ where R can be C_{X}H_{Y}X_{Z}A_{U} as described above. Amines can include aliphatic amines such as monoethylamine, diethylenetriamine, triethylenetetraamine, and the like, alicyclic amines, aromatic amines such as cyclic aliphatic amines, cyclo aliphatic amines, amidoamines, polyamides, dicyandiamides, imidazole derivatives, and the like, or any combination thereof.

In an embodiment, under step 14 of FIG. 1, any of the layers on the low friction material or composite material 1000, 1002, 1003, as described above, can each be disposed in a roll and peeled therefrom to join together under pressure, at elevated temperatures (hot or cold pressed or rolled), by an adhesive, or by any combination thereof. Any of the layers of the low friction material 1000, as described above, may be laminated together such that they at least partially overlap one another. Any of the layers on the low friction material 1000, 1002, 1003, as described above, may be applied together using coating technique, such as, for example, physical or vapor deposition, spraying, plating, powder coating, or through other chemical or electrochemical techniques. In a particular embodiment, the low friction layer 1104 may be applied by a roll-to-roll coating process, including for example, extrusion coating. The low friction layer 1104 may be heated to a molten or semi-molten state and extruded through a slot die onto a major surface of the substrate 1119. In another embodiment, the low friction layer 1104 may be cast or molded.

In an embodiment, the low friction layer 1104 can be glued or otherwise adhered to the substrate 1119 to form a laminate. In an embodiment, the low friction layer 1104 or any layers can be glued or otherwise adhered to the substrate 1119 using the melt adhesive layer 1121 to form a laminate. In an embodiment, the low friction layer 1104 or any layers can be glued or otherwise adhered to the substrate 1119 as a polymer tape to form a laminate. In an embodiment, any of the intervening or outstanding layers on the material or low friction material 1000, 1002, 1003, may form the laminate. The laminate can be cut into strips or blanks that can be formed into the bearing. The cutting of the laminate may include use of a stamp, press, punch, saw, or may be machined in a different way. Cutting the laminate can create cut edges including an exposed portion of the substrate 1119.

In other embodiments, under step 14 of FIG. 1, any of the layers on the low friction material 1000, 1002, 1003, as described above, may be applied by a coating technique, such as, for example, physical or vapor deposition, spraying, plating, powder coating, or through other chemical or electrochemical techniques. In a particular embodiment, the low friction layer 1104 may be applied by a roll-to-roll coating process, including for example, extrusion coating. The low friction layer 1104 may be heated to a molten or semi-molten state and extruded through a slot die onto a major surface of the substrate 1119. In another embodiment, the low friction layer 1104 may be cast or molded.

Referring now to the third step 16 of the forming process 10 as shown in FIG. 1, according to certain embodiments, forming the low friction material 1000, 1002, 1003 into a bearing may include a cutting operation. In an embodiment, the cutting operation may include use of a stamp, press, punch, saw, deep draw, or may be machined in a different way. In a number of embodiments, the cutting operation may form a peripheral surface on the low friction material. The cutting operation may define a cutting direction initiated from a first major surface to a second major surface, opposite the first major surface, to form the peripheral surfaces or edges. Alternatively, the cutting operation may define a cutting direction initiated from the second major surface to the first major surface to form the peripheral surfaces or edges. The low friction material may now be shaped to a bearing for the desired application.

After shaping the low friction material, the low friction material or bearing may be cleaned to remove any lubricants and oils used in the forming and shaping process. Additionally, cleaning can prepare the exposed surface of the substrate for the application of the coating. Cleaning may include chemical cleaning with solvents and/or mechanical cleaning, such as ultrasonic cleaning.

As a result of the method of FIG. 1, according to embodiments described above, the low friction layer 1104, which covers the substrate 1119 in the substrate, may be textured to have microscopically minute asperities (e.g., apexes and nadirs on a surface), which forms the low friction surface, instead of variation in macroscopic thickness of the low friction layer 1104 itself. The low friction surface may be one of the surfaces of the low friction layer 1104, that is, the surface on the side opposite the substrate 1119, as shown in FIG. 2C.

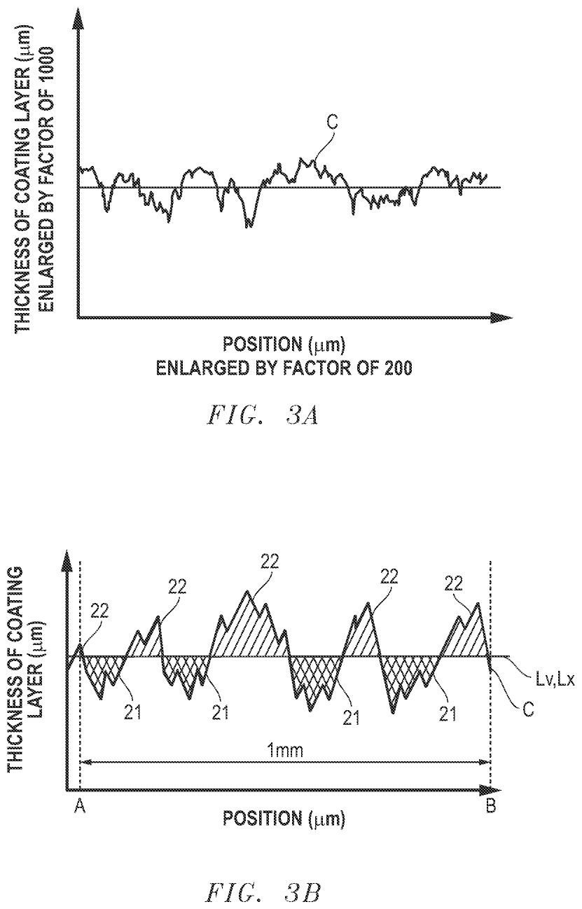

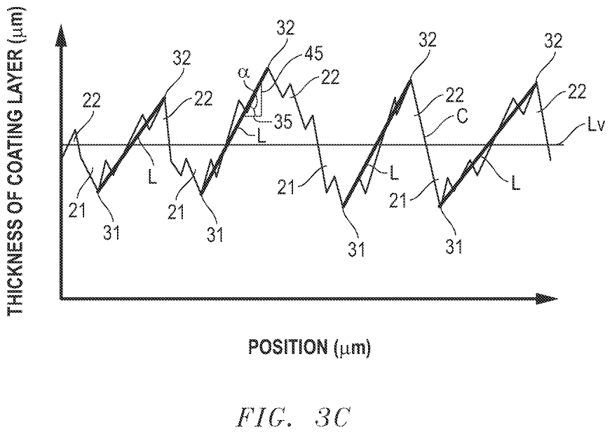

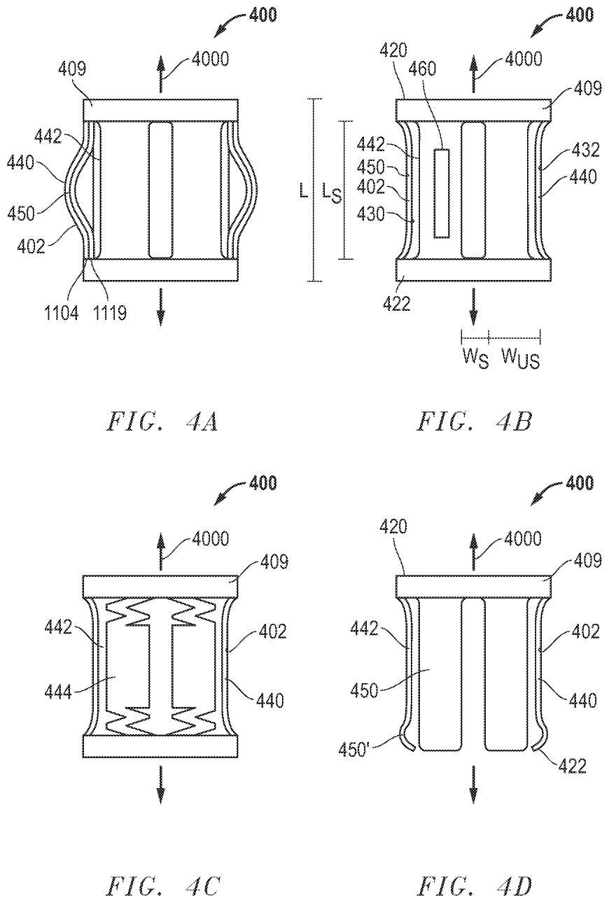

FIG. 3A is an enlarged view with the X-axis enlarged by a factor of 200 and the Y-axis enlarged by a factor of 1000. The surface shape of the low friction layer 1104 is acquired as a shape line C shown in FIG. 3. The shape line C represents the apexes and nadirs of the surface of the low friction layer 1104 in a cross section containing a plane parallel to the thickness direction of the low friction layer 1104. The shape line C is expressed by using an X-Y coordinate system. Specifically, the X-axis represents a position between two arbitrary points, and the Y-axis represents the thickness direction of the low friction layer 1104, that is, the position in the Y-axis direction represents the depth and height of the apexes and nadirs of the surface. The shape line C therefore contains apexes and nadirs according to the surface shape of the low friction layer 1104.

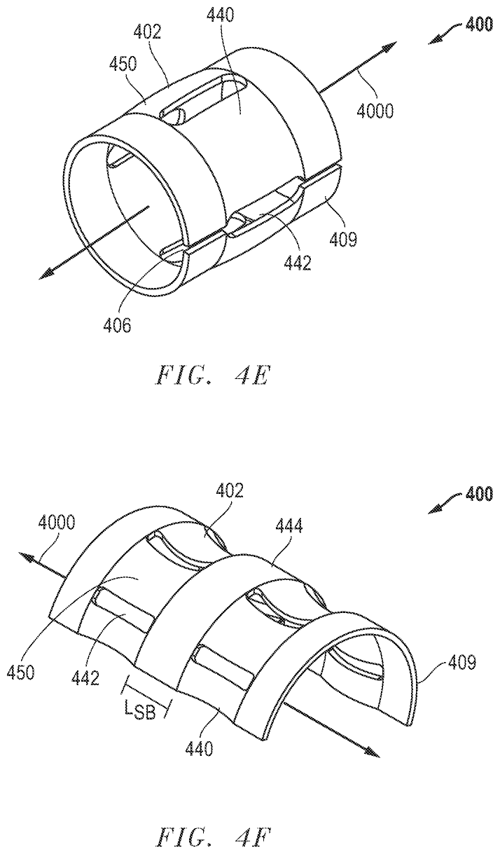

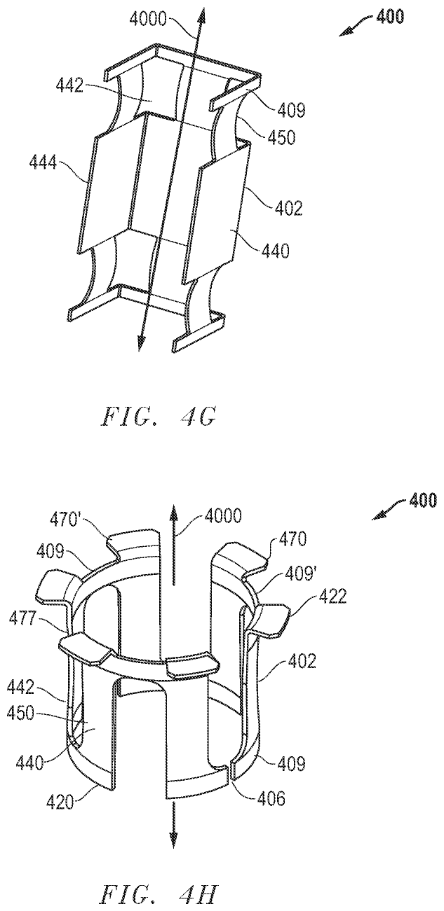

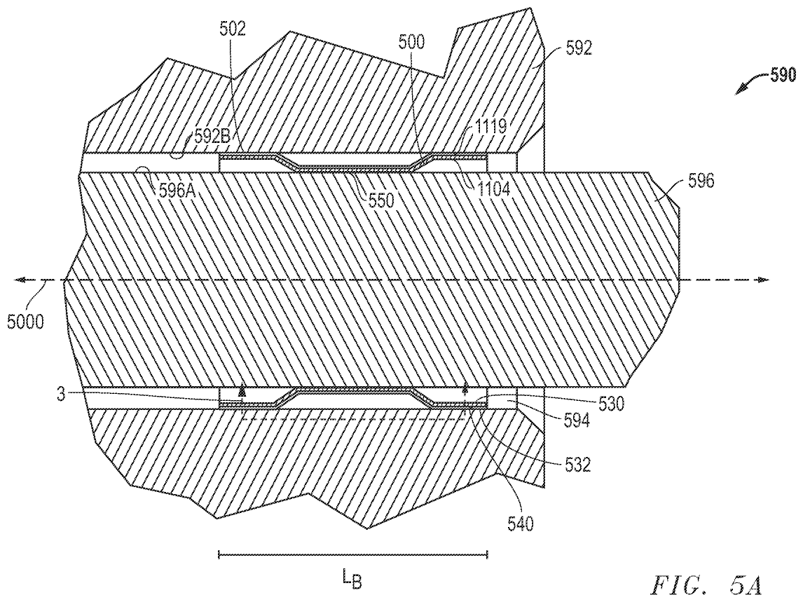

FIG. 3B diagrammatically shows a simplified version of the shape line C shown in FIG. 3A for the sake of illustration. The shape line C containing apexes and nadirs is divided by an imaginary straight line Lx, which is parallel to the X axis as a reference, into upper and lower parts in the Y-axis direction. In a case where the low friction surface of the low friction layer 1104 is microscopically flat, the low friction surface of the low friction layer 1104, the X-axis, and the imaginary straight line Lx are parallel to one another. When the shape line C is divided by the imaginary straight line Lx, recessed regions (nadirs) that protrude downward from the imaginary straight line Lx and protruding regions (apexes) that protrude upward from the imaginary straight line Lx are separated from each other. In FIG. 4, the recessed regions are “meshed,” and the protruding regions are “hatched.” The imaginary straight line Lx, which is so positioned that the sum S1 of the areas of the recessed regions is equal to the sum S2 of the areas of the extended regions, is defined as an extension and recess average line Lv. That is, across the low friction surface of the low friction layer 1104, the sum S1 of the areas of the recessed regions that protrude downward from the extension and recess average line Lv is equal to the sum S2 of the areas of the protruding regions that protrude upward from the extension and recess average line Lv (S1=S2). The regions that protrude downward from the extension and recess average line Lv are defined as nadirs 21, and the regions that protrude upward from the extension and recess average line Lv are defined as apexes 22.

In the present embodiment, the X-axis is defined in the center position in the circumferential direction and the radial direction of the surface of the low friction layer 1104 or low friction material and defined as the direction tangential to the circumferential direction for measurement. The arbitrary two points can be arbitrarily adjusted in terms of the number of locations, the positions, and the direction in the measurement in consideration of the application of the low friction layer 1104.

FIG. 3C diagrammatically shows a simplified version of the shape line C shown in FIG. 3B for the sake of illustration. In the present embodiment, the performance of the low friction layer 1104 or low friction material is further verified by using the relationship between a nadir 21 and an apex 22 adjacent to each other. Each of the nadirs 21 has a bottom 31 in the deepest position of the nadir 21, that is, in the position closest to the substrate 1119. The extension 22 adjacent to the nadir 21 has an apex 32 in the highest position of the apex 22, that is, in the position farthest from the substrate 1119. As described above, when a nadir 21 and an apex 22 are adjacent to each other with the extension and recess average line Lv therebetween, the bottom 31 of the nadir 21 and the apex 32 of the apex 22 can be connected to each other with an imaginary straight line L. The gradient of the straight line L is the value calculated by dividing a measured distance between the bottom 31 of the nadir 21 and the apex 32 of the apex 22 in the Y-axis direction, 45, by a measured distance between the bottom 31 and the apex 32 in the X-axis direction, 35. The average of the gradients of the resultant straight lines L is an average gradient SDQ or the root mean square gradient. In a number of embodiments, the root mean square gradient of the low friction material may be less than 0.064.

Further, the root mean square gradient may have an average angle α from the nadir to the apex. The angle α may be at least 0.01°, such as 0.05°, such as 0.1°, such as 0.15°, such as 0.5°, such as 1°, such as 1.5°, such as 2°, or such as 3°.

Further, the apex material portion, Smr1, may be calculated as the percentage of the low friction material that includes the apexes. In other words, the thickness of the substrate may be termed T_{S}, and Smr1 is the area material ratio that divides the reduced apexes of the total thickness of the low friction material, T_{SL}, from the thickness of the substrate or core surface T_{S}. The reduced apexes are the areas that are removed by initial abrasion with a neighboring component. In a number of embodiments, the apex material portion, Smr1, of the low friction material may be less than 10%.

Further, the nadir material portion, Smr2, may be calculated as the percentage of the low friction material that includes the nadirs. In other words, the thickness of the substrate may be termed T_{S}, and Smr2 is the area material ratio that divides the reduced nadirs of the total thickness of the low friction material, T_{S} from the thickness of the substrate or core surface T_{S}. The reduced nadirs are the areas that hold liquid (e.g., grease) applied on the surface in order to improve lubricity. In a number of embodiments, the nadir material portion, Smr1, of the low friction material may be less than 75%. The resulting textured low friction layer 1104 may have a minimum distance between at least one apex 22 of the plurality of apexes 22 and at least one nadir 21 of the plurality of nadirs 21 may be 0.05 mm.

FIGS. 4A-4H depict a bearing 400 including embodiments formed from a blank of material or composite material 1000, 1002, 1003 as described above. FIGS. 4A-4H include similar features as shown in FIGS. 2A-2C and labeled as such. For a description of those elements, please refer to the prior description of FIGS. 2A-2C. Referring initially to FIG. 4A, the bearing 400 may include a sidewall 402 having a first axial end 420, and a second axial end 422. As shown in FIG. 4A, the sidewall 402 may be formed from a blank as described above and include a substrate 1119 (e.g., spring steel) that may be curved into a ring-like (substantially annular or at least partially annular) shape about a central axis 4000, forming an aperture. The sidewall 402 may further include a low friction layer 1104 that conforms to the shape of the sidewall 402, as formed as a low friction layer 1104 from the blank of composite material 1000, 1002, 1003 as described above. In some embodiments, the sidewall 402 may be curved so that the ends overlap with one another. In yet further embodiments, the sidewall may be a continuous, unbroken ring. Alternatively, as shown best in FIG. 4E, the ends of the sidewall 402 may not meet (e.g., it may be formed as a split ring), thereby leaving an axial gap 406 adjacent the circumference of the sidewall 402.

Referring back to FIG. 4A, the bearing 400 and/or sidewall 402 may have an inner surface 430, and an outer surface 432. In a number of embodiments, the inner surface 430 of the bearing 400 and/or sidewall 402 may have a low friction layer 1104 that conforms to the shape of the sidewall 402 with the substrate 1119 forming the outer surface 432, as formed from the composite material 1000, 1002, 1003 as described above. In other words, the low friction layer 1104 may be located on the outside of the sidewall 402. Alternatively or additionally, the outer surface 432 of the bearing 400 may have a low friction layer 1104 that conforms to the shape of the sidewall with the substrate 1119 forming the inner surface 430, as formed from the composite material 1000, 1002, 1003 as described above. In other words, the low friction layer 1104 may be located on the inside of the sidewall 402. In other embodiments, the low friction layer 1104 may be laminated onto both surfaces of the bearing 400 and/or sidewall 402.

As shown in FIG. 4A, in a number of embodiments, the sidewall 402 of the bearing can include a flat, circumferentially extending rim 409 of composite material at least one axial end 420, 422 of the bearing 400. Alternatively, as shown in FIG. 4D, the flat, circumferentially extending rim 409 may be located at just one axial end 422 of the bearing 400. The circumferentially extending rim 409 may be uniform and run at least part of a circumference of the bearing 400 about the central axis 4000. Alternatively, in a number of embodiments as shown in FIG. 4H, the circumferentially extending rim 409 may be discrete and include a plurality of circumferentially extending rims 409, 409′ between neighboring slots 442. Further, the sidewall 404 of the bearing 400 can include at least one slot 442 that can extend radially through the sidewall 402. The at least one slot 442 may include a plurality of slots 442 that can extend radially through the sidewall 402. Each slot 442 also may be spaced from its neighboring slot 442 by at least one unformed section 440 the bearing 400, which may be contiguously formed with rims 409 and spaced circumferentially. In other words, the unformed section 440 may include the rim 409 and be disposed at least one of the axial ends 420, 422 of the bearing 400. In an embodiment, the at least one slot 442 may run at least 5%, such as at least 10%, such as at least 15%, such as at least 25%, such as at least 35%, or such as at least 50% of an axial length of the sidewall 402. In an embodiment the at least one slot 442 (or unformed section 440) formed in the sidewall 402 can be different sized, different shaped, or different sized and shaped from one another. In another aspect, the at least one slot 442 (or unformed section 440) can include a first end and a second end and each end can be rounded, as shown best in FIG. 4B. Further, the at least one slot 442 may be centered circumferentially and longitudinally within each unformed section 440. The at least one slot 442 (or unformed section 440) may be formed via punch, stamp, cut, or by another method.

In an embodiment, at least one of the slots 442 may have a polygonal cross-section from the central axis 4000. In an embodiment, at least one of the slots 442 may have an arcuate cross-section from the central axis 4000. In yet another embodiment, as shown in FIGS. 4A-4B, at least one of the slots 442 may have an arcuate portion and a polygonal portion. In another embodiment, at least one of the slots 442 may have a semi-circular or semi-oval cross-section from the central axis 4000. In another embodiment, as shown in FIG. 4C, at least one of the slots 442 may have a variable cross-section (including, for example, areas of rectilinear space and areas of arcuate space) from the central axis 4000. In an embodiment, at least two of the slots 442 may have the same geometric shape or size as compared to each other. In a further embodiment, all of the slots 442 may have the same geometric shape or size as compared to each other. In another embodiment, at least one of the slots 442 may have different geometric shapes or sizes as compared to each other. In a further embodiment, all of the slots 442 may have different geometric shapes or sizes as compared to each other. In a specific embodiment, as shown in FIG. 4E, a slot 442 may span the axial gap 406.

Referring back to FIG. 4A, in a particular aspect, the sidewall 402 may have a length, L, and the at least one slot may have a length, L_{S}. Further, L_{S}≥80% L, such as ≥85% L, or ≥90% L. In another aspect, L_{S}≤99% L, such as ≤98% L, ≤97% L, ≤96% L, ≤95% L. Moreover, L_{S} can be within a range between, and including, any of the percentage of L values described herein.

In another aspect, at least one unformed section 440 may have a width, W_{US}. Further, each slot 442 may have a width, W_{S}. In a particular aspect, W_{S} can be ≥50% W_{US}, such as ≥55% W_{US}, ≥60% W_{US}, ≥65% W_{US}, ≥70% W_{US}, ≥75% W_{US}, ≥80% W_{US}, ≥85% W_{US}, or ≥90% W_{US}. In another aspect, W_{S} can be ≤99% W_{US}, such as ≤98% W_{US}, ≤97% W_{US}, ≤96% W_{US}, ≤95% W_{US}. W_{S} can be within a range between, and including, any of the percentage of W_{US} values described above.

In another aspect, at least one unformed section 440 may have a length L_{S} and a width W_{S} where L_{S}:W_{S} can be at least 1:1, at least 1.5:1, at least 2:1, at least 2.5:1, at least 3:1, at least 5:1, or at least 10:1. Further, L_{S}:W_{S} can be no greater than 100:1. L_{S}:W_{S} can be within a range between, and including, any of the percentage of values described above.

Referring back to FIG. 4A, the sidewall 402 and/or at least one unformed section 440 may include at least one protrusion 450 extending from the sidewall 402. In a number of embodiments, the at least one protrusion 450 may include a plurality of protrusions 450. In an embodiment, the protrusion 450 may extend along an axial length of the unformed section 440. In an embodiment, the protrusion 450 may extend the entire axial length of the unformed section 440. In an embodiment, the protrusion 450 may extend the entire surface area of the unformed section 440. As shown in FIG. 4A, at least one protrusion 450 may extend from the unformed section and form a generally convex cross-sectional shape in the sidewall 402. Alternatively, as shown in FIG. 4B, at least one protrusion 450 may extend from the unformed section and form a generally concave cross-sectional shape in the sidewall 402. Alternatively still, as shown in FIG. 4D, at least one protrusion 450 may extend from the unformed section and form a generally concave cross-sectional shape in the sidewall 402, and, at least one protrusion 450′ may extend from the unformed section and form a generally convex cross-sectional shape in the sidewall 402. In an embodiment, the at least one protrusion 450 may be rounded or arcuate in a radial direction relative to the central axis 4000. In an embodiment, the at least one protrusion 450 may be rectilinear or polygonal in the radial direction relative to the central axis 4000. In an embodiment, the protrusions 450 and slots 442 may be ordered alternatively around the sidewall 402. In an embodiment, at least two protrusions 450 or at least two slots 442 may be ordered sequentially around the sidewall 402.

In a number of embodiments, the at least one protrusion 450 may include at least one projection 460 that extend radially inward or outward from the outer surface 432 or inner surface 430 of the bearing 400. The at least one projection 460 may be located on an unformed section 440 or the circumferential rim 409. The projection 460 may be formed from the composite material 1000, 1002, 1003 via stamping (e.g., pressed using a suitably shaped mold, rotary wave forming, etc.). The protrusions 460 may be axially elongated ridges that may be similar in shape to waves used on conventional bearings. In another embodiment, the protrusions 460 may have a polygonal cross-section from the central axis 4000. The protrusions 460 may include at least one polygonal angle. In yet another embodiment, at least one of the protrusions 460 may have an arcuate portion and a polygonal portion. In another embodiment, the protrusions 460 may have a semi-circular cross-section from the central axis 4000. In another embodiment, the protrusions 460 may have a variable cross-section from the central axis 4000. In an embodiment, at least two of the protrusions 460 may have the same geometric shape or size as compared to each other. In a further embodiment, all of the protrusions 460 may have the same geometric shape or size as compared to each other. In another embodiment, at least one of the protrusions 460 may have different geometric shapes or sizes as compared to each other. In a further embodiment, all of the protrusions 460 may have different geometric shapes or sizes as compared to each other.

FIGS. 4C, 4F, and 4G illustrate another bearing 400 formed with slots 442 in the unformed sections 440 of the sidewall 402. As illustrated, the slots 442 can be bifurcated, or otherwise split, by a slot bridge 444. In some particular embodiments, the unformed section 440 may include the slot bridge 444 and be disposed at an axial midpoint of the bearing 400. As shown in FIG. 4F, the slot bridge 444 may divide generally convex or generally concave sections of the sidewall 402. The slot bridge 444 may have a length, L_{SB}, where L_{SB}≥15% L, such as ≥20% L, or ≥25% L. In another aspect, L_{SB}≤80% L, such as ≤75% L, ≤60% L, ≤55% L, ≤50% L. Moreover, L_{SB} can be within a range between, and including, any of the percentage of L values described herein.

Further, as shown in exemplary FIGS. 4F and 4G, the bearing 400 may include different cross-sectional shapes perpendicular to the central axis. As shown in exemplary FIG. 4F, the bearing 400 may include an annular cross-sectional shape perpendicular to the central axis. As shown in exemplary FIG. 4F, the bearing 400 may include a polygonal or rectilinear cross-sectional shape perpendicular to the central axis.

FIG. 4H illustrates another bearing 400 formed with slots 442 in the unformed sections 440 of the sidewall 402. As shown in FIG. 4H, the bearing 400 may include at least one radial flange 470. In a number of embodiments, the at least one radial flange 470 may be disposed at least one of the axial ends 420, 422 of the bearing 400. The at least one radial flange 470 can be generally annular about the central axis 4000. The at least one radial flange 470 may extend radially outward from the inner surface 430 to the outer surface 432. Alternatively, the radial flange 470 may extend radially inward from the outer surface 432 to the inner surface 430 (not shown). In a number of embodiments, the radial flange 470 may form a generally planar outermost axial surface at the first axial end 420 or the second axial end 422 of the bearing 400. In a number of embodiments, the radial flange 470 may form a generally planar outermost radial surface at the outer surface 432 of the first axial end 420 or the second axial end 422 of the bearing 400. In a number of embodiments, the radial flange 470 may be an extension of the inner surface 430 and outer surface 432 and thus may include a low friction layer 1104 that conforms to the shape of the sidewall 402, as formed as a low friction layer 1104 from the blank of composite material 1000, 1002, 1003 as described above.

In a number of embodiments, the flange may be uniform and run at least part of a circumference of the bearing 400 about the central axis 4000. In a number of embodiments, the at least one radial flange may include a plurality of flanges 470, 470′. In a number of embodiments, as stated above, the radial flange 470 may include at least one axial split 477 to form a “star-shaped flange.” The axial split 477 may provide a gap in the flange 470. In a number of embodiments, the flange 470 may include a plurality of axial splits 477 providing a segmented flange. In certain embodiments, the axial split 477 can be contiguous with an axial gap 406 in the sidewall 402. In other embodiments, the axial split 477 can be non-contiguous with the axial gap 406 in the sidewall 402. In other words, in a number of embodiments, the plurality of flanges 470, 470′ may be discrete in the form of radial tabs.

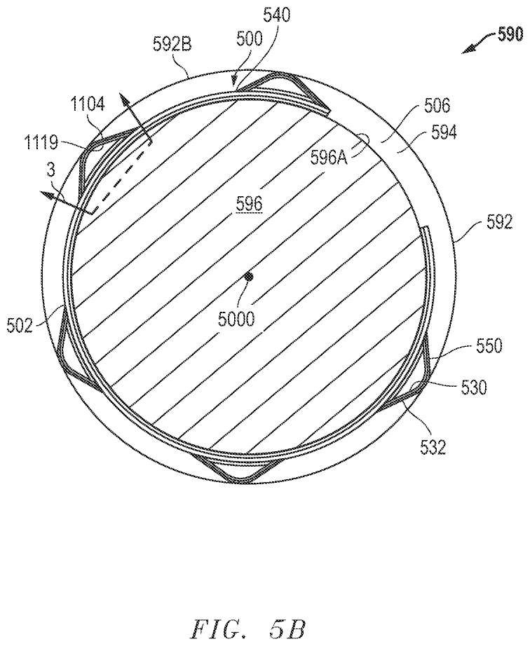

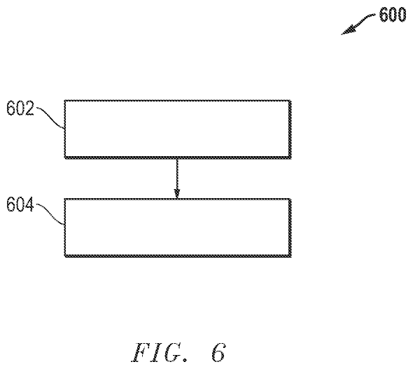

In operation, the bearing may be located adjacent to an opposing component. In operation, the bearing may be located between two opposing (mating) components. For example, it may be located in the annular space between an inner component (e.g., a shaft) and a bore in an outer component (e.g., a housing). In other words, the inner component contacts the inner surface of the bearing and the outer component contacts the outer surface of the bearing. FIG. 5A depicts an axial sectional view through an assembly 590 including an embodiment of a bearing 500. FIGS. 5A-5B include similar features as shown in FIGS. 4A-4H and labeled as such. For a description of those elements, please refer to the prior description of FIGS. 4A-4H. The assembly 590 incorporates, for example, the bearing 500 shown in FIG. 4B. Therefore, FIG. 5A includes similar features as shown in FIG. 4B and labeled as such. For a description of those elements, please refer to the prior description of FIG. 4B. The assembly 590 includes a housing 592 or outer component. The housing 592 may have an axial bore 594 formed therein, which receives a shaft 596 or inner component.

An annular gap exists between the outer surface 596A of shaft 596 and the inner surface 592B of housing 592. The size of this annular gap may be variable because the diameter of the shaft 596 and the bore 594 of the housing 592 may vary within manufacturing tolerances. To prevent vibration of the shaft 596 within the bore 594 of the housing 592, the annular gap may be filled by bearing 500 to form a zero-clearance fit between the components. FIG. 5A shows that the bearing 500 includes a sidewall 502 with the substrate 1119 on the outer surface 532 and a low friction layer 1104 on the inner surface 530. Further, in this embodiment, the protrusions 550 extend radially inward toward the inner component 596. In use, the circumferential protrusions 550 of the bearing 500 may be radially compressed in the annular gap between the shaft 596 and housing 592, such that the protrusions 550 contact the inner component 596. The bearing 500 therefore reduces the annular gap to zero so there may not be a clearance between the components in the assembly 590. The bearing 500 may be secured relative to the housing 592 by frictional engagement at the contact area between the sidewall 502 and the inner surface 592B of the housing 592 or outer component. The low friction layer 1104 may reduce required torque during use of the bearing 500 within the assembly 590 while maintaining a desired torque range.

FIG. 5B depicts an axial sectional view through an assembly 590 including another embodiment of a bearing 500. The assembly 590 incorporates, for example, the bearing 500 shown in FIG. 4B. Therefore, FIG. 5B includes similar features as shown in FIG. 4A and labeled as such. For a description of those elements, please refer to the prior description of FIG. 4A. The assembly 590 may also include housing 592 or outer component and shaft 596 or inner component. In the embodiment shown, the bearing 500 may be retained on the shaft 596. The outer diameter of the shaft 596 may be greater than an inner diameter of an exemplary bearing 500 as shown in FIG. 4B at rest. Thus, the bearing 500 may expand (axial gap 506 must widen) to fit the bearing 500 around the surface 596A of the shaft 596. Further, in this embodiment, the protrusions 550 extend radially outward toward the outer component 592. Inside the bore 594 of housing 592, the protrusions 550 may be compressed in the annular gap or space between the components at inner surface 592B of the housing 592.

FIG. 5B shows that the bearing 500 includes a sidewall 502 with the substrate 1119 on the inner surface 530 and a low friction layer 1104 on the outer surface 532. In use, the circumferential protrusions 550 of the bearing 500 may be radially compressed in the annular gap between the shaft 596 and housing 592, such that the protrusions 550 contact the outer component 592. The bearing 500 therefore reduces the annular gap to zero so there may not be a clearance between the components in the assembly 590. The bearing 500 may be secured relative to the housing 592 by frictional engagement at the contact area between the sidewall 502 and the outer surface 596A of the inner component 596. The low friction layer 1104 may reduce required torque during use of the bearing 500 within the assembly 590 while maintaining a desired torque range. Further, optionally, projections 560 on the bearing 500 may be compressed within the assembly 590 in a similar way.

As stated above, the bearing 500 may be located between two opposing (mating) components within an assembly 590. For example, it may be located in the annular space between a first component (e.g., a shaft) and a bore in a second component (e.g., a housing). The first or second component may be made of any materials known in the art including, but not limited to, aluminum, magnesium, zinc, iron, or an alloy thereof. The surface roughness of the opposing component can be at least about 0.01 micron, at least about 0.02 micron, at least about 0.05 micron, at least about 0.1 micron, at least about 0.5 micron, at least about 1 micron, at least about 2 microns, at least about 5 microns, at least about 10 microns, at least about 20 microns, at least about 50 microns, at least about 100 microns, at least about 200 microns, or at least about 400 microns. In other embodiments, the surface roughness may be less than about 400 microns, less than about 200 microns, less than about 100 microns, less than about 50 microns, less than about 25 microns, less than about 20 microns, less than about 15 microns, less than about 10 microns, less than about 5 microns, less than about 3 microns, less than about 2 microns, or even less than about 1 micron. In yet another embodiment, the opposing component can have a surface roughness in the range from about 0.1 micron to about 400 microns, from about 0.5 micron to about 100 microns, or from about 1 micron to about 50 microns. In a particular embodiment, the surface of at least one of the first component or the second component has a surface roughness of less than 0.4 microns. At least one of the inner or outer of the bearing 500 may contact the opposing component to create a low friction interface.

In at least one embodiment, the assembly 590 may include a lubricant on any of its components. In at least one embodiment, the lubricant may include a grease including at least one of lithium soap, lithium disulfide, graphite, mineral or vegetable oil, silicone grease, fluoroether-based grease, apiezon, food-grade grease, petrochemical grease, or may be a different type. In at least one embodiment, the lubricant may include an oil including at least one of a Group I-Group III+ oil, paraffinic oil, naphthenic oil, aromatic oil, biolubricant, castor oil, canola oil, palm oil, sunflower seed oil, rapeseed oil, tall oil, lanolin, synthetic oil, polyalpha-olefin, synthetic ester, polyalkylene glycol, phosphate ester, alkylated naphthalene, silicate ester, ionic fluid, multiply alkylated cyclopentane, petrochemical based oil, PTFE thickened grease or may be a different type. In at least one embodiment, the lubricant may include a solid based lubricant including at least one of lithium soap, graphite, boron nitride, molybdenum disulfide, tungsten disulfide, polytetrafluoroethylene, a metal, a metal alloy, or may be a different type. In a number of embodiments, the grease may be present on at least 25% of the total surface area of the bearing. In a number of embodiments, the nadirs in the low friction layer may contain or house the grease.

As a result of embodiments herein, an assembly 590 may be formed. The assembly 590 may include an outer component 592 including a bore 594 within the outer component 592; an inner component 596 disposed within the inner component 596 and the outer component 592, the bearing 500 including a sidewall 502 including a substrate 1119, and a low friction layer 1104 overlying the substrate, where the sidewall further includes an unformed section 540, at least one slot 532 in the unformed section, and at least one protrusion 550 extending from the unformed section forming a generally concave or convex cross-sectional shape in the sidewall. The bearing 500 may have a frictional torque with the inner component 596 or outer component 594 where a frictional torque variation of the assembly 590 over a lifetime of at least 1 million cycles and a temperature range of −40° C. to 80° C. may be within ±20%. Further, the bearing 500 within the assembly 590 may have a ware rate of less than 0.01 mm/100 k rotations.

FIG. 6 depicts a method according to a number of embodiments. As shown in FIG. 6, the method may include step 602 of positioning a bearing between the inner component and the outer component, the bearing including: a sidewall including a substrate and a low friction layer overlying the substrate, where the sidewall further includes: an unformed section; at least one slot in the unformed section; and at least one protrusion extending from the unformed section forming a generally concave or convex cross-sectional shape in the sidewall. Optionally, the method may further include step 604 of rotating or translating the bearing to form a frictional torque with the inner or outer component, where a frictional torque variation of the assembly over a lifetime of at least 1 million cycles and a temperature range of −40° C. to 80° C. may be within ±20%.

### Examples

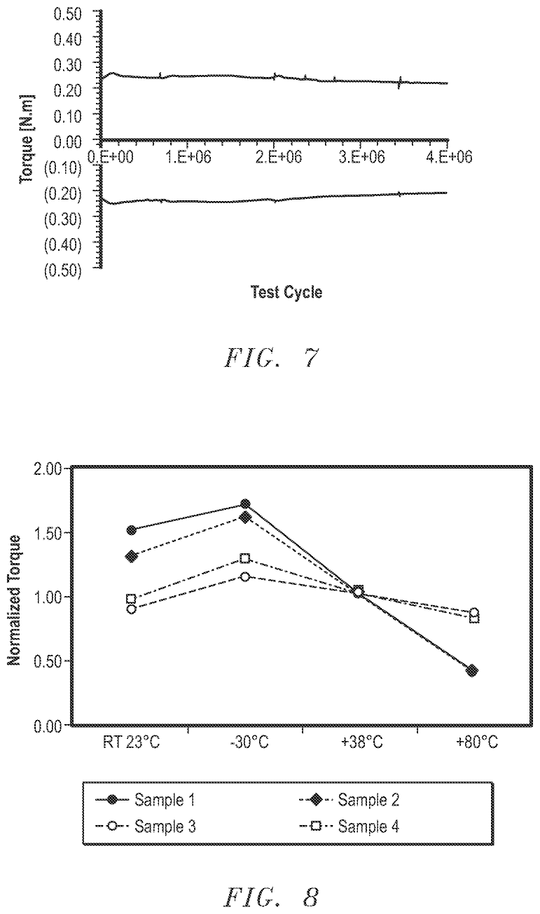

FIG. 7 includes a graph of a frictional torque curve vs. test cycles of a bearing in accordance with an embodiment. As shown in FIG. 7, the frictional torque curve of a bearing in accordance with embodiments (specifically the embodiment of FIG. 4B) herein may be obtained by placing the bearing between a shaft having a surface roughness of 0.2 microns and a housing. The bearing may be rotated at 200 rpm speed with 1 period containing clockwise rotation for 5 seconds, stop 5 seconds, counter-clockwise rotation for 5 seconds, stop 5 seconds. Each period may contain 30-40 cycles (e.g., 33 cycles). A total of 60,000 periods were tested. As shown in FIG. 7, the frictional torque fluctuation may be less than +/−0.3 N·m for 4 million cycles. As shown, bearings according to embodiments herein may provide initial contact pressure and have compensation over the wear of the sliding layer over time, while the sliding layer may have stable coefficient of friction and low wear rate. These two factors may provide stable torque over the lifetime of the bearing where torque drop within the assembly is only 7% after 2 million test cycles and 15% over 4 million test cycles, respectively. According to embodiments herein, bearing within assemblies may show a frictional torque variation of the assembly over a lifetime of at least 1 million cycles and a temperature range of −40° C. to 80° C. may be within ±20%.

FIG. 8 includes a graph of a normalized torque curve vs. temperature of a bearing with shaft samples of differing surface roughness in accordance with an embodiment. As shown in FIG. 8, normalized torque was calculated as the torque value average for different temperatures as shown. The data was calculated for a bearing in accordance with embodiments (specifically the embodiment of FIG. 4B) with a shaft having a surface roughness of 0.1 microns, and 0.2 microns and a housing using the same test of FIG. 7 described above. As shown in FIG. 8, the normalized torque decreases as temperature decreases. As shown, bearings according to embodiments herein may provide initial contact pressure and have compensation over the wear of the sliding layer over time, while the sliding layer may have relatively stable coefficient of friction and low wear rate within certain temperature range. These two factors may provide stable torque of the bearing over the temperature range of −30° C. to 80° C. where torque drop within the assembly is within ±20%.

Applications for embodiments include, for example, assemblies for hinges and other vehicle components. Further, use of the bearing or assembly may provide increased benefits in several applications such as, but not limited to, door, hood, tailgate, engine compartment hinges, seats, steering columns, flywheels, driveshaft assemblies, powertrain applications (such as belt tensioners), or other types of applications. According to particular embodiments herein, the bearings may be part of a friction brake or spindle drive used in, but not necessarily limited to, a vehicle door assembly.

Bearings according to embodiments herein may provide improved constant friction torque over a lifetime of an assembly. This may allow vehicle door assemblies to stop the door at any position and compensate spring force for more reliable safety control. Further, bearings according to embodiments herein may decrease noise/vibration, reduce wear of the bearing surface and the mating components, and reduce complex componentry and assembly time, thereby increasing lifetime, improving visual appearance, and improving effectiveness and performance of the assembly, the bearing, and its other components.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the embodiments as listed below.

Embodiment 1: A bearing, comprising: a sidewall comprising a substrate and a low friction layer overlying the substrate, wherein the sidewall further comprises: an unformed section; at least one slot in the unformed section; and at least one protrusion extending from the unformed section forming a generally concave cross-sectional shape in the sidewall.

Embodiment 2: A bearing, comprising: a sidewall comprising a substrate and a low friction layer overlying the substrate, wherein the sidewall further comprises: an unformed section; at least one slot in the unformed section; and at least one protrusion extending from the unformed section forming a generally convex cross-sectional shape in the sidewall.

Embodiment 3: An assembly, comprising: an outer component including a bore within the outer component; an inner component disposed within the bore; and a bearing disposed between the inner component and the outer component, the bearing comprising: a sidewall comprising a substrate and a low friction layer overlying the substrate, wherein the sidewall further comprises: an unformed section; at least one slot in the unformed section; and at least one protrusion extending from the unformed section forming a generally concave or convex cross-sectional shape in the sidewall.

Embodiment 4: An assembly, comprising: an outer component including a bore within the outer component; an inner component disposed within the bore; and a bearing disposed between the inner component and the outer component and fixed to the outer component, the bearing comprising: a sidewall comprising a substrate and a low friction layer overlying the substrate, wherein the sidewall further comprises: an unformed section; at least one slot in the unformed section; and at least one protrusion extending from the unformed section forming a generally concave or convex cross-sectional shape in the sidewall, wherein the bearing has a frictional torque with the inner or outer component, wherein a frictional torque variation of the assembly over a lifetime of at least 1 million cycles and a temperature range of −40° C. to 80° C. is within ±20%.

Embodiment 5: A method, comprising: positioning a bearing between the inner component and the outer component, the bearing comprising: a sidewall comprising a substrate and a low friction layer overlying the substrate, wherein the sidewall further comprises: an unformed section; at least one slot in the unformed section; and at least one protrusion extending from the unformed section, and a generally concave or convex cross-sectional shape in the sidewall.

Embodiment 6: A method, comprising: positioning a bearing between the inner component and the outer component, the bearing comprising: a sidewall comprising a substrate and a low friction layer overlying the substrate, wherein the sidewall further comprises: an unformed section; at least one slot in the unformed section; and at least one protrusion extending from the unformed section forming a generally concave or convex cross-sectional shape in the sidewall; and rotating or translating the bearing to form a frictional torque with the inner or outer component, wherein a frictional torque variation of the assembly over a lifetime of at least 1 million cycles and a temperature range of −40° C. to 80° C. is within ±20%.

Embodiment 7: The bearing, assembly, or method of any of embodiments 1-6, wherein the bearing further comprises a projection.

Embodiment 8: The bearing, assembly, or method of any of embodiments 1-6, wherein the protrusion comprises a rectilinear protrusion in a radial direction.

Embodiment 9: The bearing, assembly, or method of any of embodiments 1-6, wherein the protrusion comprises an arcuate protrusion in a radial direction.

Embodiment 10: The bearing, assembly, or method of any of embodiments 1-6, wherein the slot runs at least 50% of an axial length of the sidewall.

Embodiment 11: The bearing, assembly, or method of any of embodiments 1-6, wherein the at least one slot comprises a length, L_{S}, and a width, W_{S}, and L_{S}:W_{S}≥2:1.

Embodiment 12: The bearing, assembly, or method of any of embodiments 1-6, wherein the at least one protrusion extends radially outward from the sidewall.

Embodiment 13: The bearing, assembly, or method of any of embodiments 1-6, wherein the at least one protrusion extends radially inward from the sidewall.

Embodiment 14: The bearing, assembly, or method of any of embodiments 1-6, wherein the at least one protrusion forms a concave cross-sectional shape in the sidewall.

Embodiment 15: The bearing, assembly, or method of any of embodiments 1-6, wherein the at least one protrusion forms a convex cross-sectional shape in the sidewall.

Embodiment 16: The bearing, assembly, or method of any of embodiments 1-6, wherein the protrusion comprises a plurality of protrusions.

Embodiment 17: The bearing, assembly, or method of any of embodiments 1-6, wherein the slot comprises a plurality of slots.

Embodiment 18: The bearing, assembly, or method of embodiment 17, wherein the protrusions and slots are ordered alternatively around the sidewall.

Embodiment 19: The bearing, assembly, or method of embodiment 17, wherein at least two protrusions or at least two slots are ordered sequentially around the sidewall.

Embodiment 20: The bearing, assembly, or method of any of embodiments 1-6, wherein the bearing comprises an annular cross-sectional shape perpendicular to a central axis.

Embodiment 21: The bearing, assembly, or method of any of embodiments 1-6, wherein the bearing comprises a polygonal cross-sectional shape perpendicular to a central axis.

Embodiment 22: The bearing, assembly, or method of any of embodiments 1-6, wherein the substrate comprises a porous metallic is selected from a mesh material, a grid, an expanded sheet, or a perforated sheet.

Embodiment 23: The bearing, assembly, or method of any of embodiments 1-6, wherein the substrate comprises a metal, plastic, or ceramic.

Embodiment 24: The bearing, assembly, or method of any of embodiments 1-6, wherein the substrate includes aluminum, magnesium, zinc, iron, or an alloy thereof.

Embodiment 25: The bearing, assembly, or method of any of embodiments 1-6, wherein the substrate comprises steel, spring steel, or stainless steel.

Embodiment 26: The bearing, assembly, or method of any of embodiments 1-6, wherein the low friction layer comprises a polyketone, polyaramid, a thermoplastic polyimide, a polyetherimide, a polyphenylene sulfide, a polyethersulfone, a polysulfone, a polyphenylene sulfone, a polyamideimide, ultra high molecular weight polyethylene, a thermoplastic fluoropolymer, a polyamide, a polybenzimidazole, or any combination thereof.

Embodiment 27: The bearing, assembly, or method of any of embodiments 1-6, wherein the low friction layer comprises a fluoropolymer.

Embodiment 28: The bearing, assembly, or method of any of embodiments 1-6, wherein the low friction layer comprises polytetrafluoroethylene.

Embodiment 29: The bearing, assembly, or method of any of embodiments 1-6, wherein the low friction layer comprises PEEK.

Embodiment 30: The bearing, assembly, or method of any of embodiments 1-6, wherein the low friction layer comprises asperities comprising a plurality of apexes and nadirs, wherein the low friction layer has a root mean square gradient of less than 0.064, wherein the low friction layer induces formation of a film when engaged in a rotational interface w/another component.

Embodiment 31: The bearing, assembly, or method of any of embodiments 1-6, wherein the low friction layer is located on the outside of the sidewall.

Embodiment 32: The bearing, assembly, or method of any of embodiments 1-6, wherein the low friction layer is located on the inside of the sidewall.

Embodiment 33: The bearing, assembly, or method of any of embodiments 1-6, wherein the sidewall comprises an axial gap.

Embodiment 34: The bearing, assembly, or method of any of embodiments 1-6, wherein the unformed section is disposed at least one of the axial ends of the bearing.

Embodiment 35: The bearing, assembly, or method of any of embodiments 1-6, wherein the unformed section is disposed near an axial midpoint of the bearing.

Embodiment 36: The bearing, assembly, or method of any of embodiments 1-6, wherein the bearing further comprises at least one radial flange.

Embodiment 37: The bearing, assembly, or method of embodiment 35, wherein the at least one radially oriented flange is disposed at least one of the axial ends of the bearing.

Embodiment 38: The bearing, assembly, or method of embodiment 35, wherein the at least one flange comprises a plurality of flanges.

Embodiment 39: The bearing, assembly, or method of embodiment 38, wherein the plurality of flanges comprise tabs.

Embodiment 40: The assembly or method of any of embodiments 3-6, wherein the bearing has a wear rate of less than 0.01 mm/100 k rotations.

Embodiment 41: The assembly or method of any of embodiments 3-6, wherein the assembly is part of a spindle drive.

Embodiment 42: The assembly or method of any of embodiments 3-6, wherein the assembly is part of a friction brake.

Note that not all of the features described above are required, that a region of a specific feature may not be required, and that one or more features may be provided in addition to those described. Still further, the order in which features are described is not necessarily the order in which the features are installed.

Certain features are, for clarity, described herein in the context of separate embodiments, may also be provided in combination in a single embodiment. Conversely, various features that are, for brevity, described in the context of a single embodiment, may also be provided separately or in any subcombinations.

Benefits, other advantages, and solutions to problems have been described above with regard to specific embodiments, however, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of assembly and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or any change may be made without departing from the scope of the disclosure. Accordingly, the disclosure is to be regarded as illustrative rather than restrictive.

What is claimed is:

1. A bearing, comprising:
a sidewall comprising a substrate and a low friction layer overlying the substrate, wherein the sidewall further comprises:
an unformed section;
at least one slot in the unformed section; and
at least one protrusion extending from the unformed section forming a generally concave cross-sectional shape in the sidewall.

2. A bearing, comprising:
a sidewall comprising a substrate and a low friction layer overlying the substrate, wherein the sidewall further comprises:
an unformed section;
at least one slot in the unformed section; and
at least one protrusion extending from the unformed section forming a generally convex cross-sectional shape in the sidewall.

3. An assembly, comprising:
an outer component including a bore within the outer component;
an inner component disposed within the bore; and
a bearing disposed between the inner component and the outer component, the bearing comprising:
a sidewall comprising a substrate and a low friction layer overlying the substrate, wherein the sidewall further comprises:
an unformed section;
at least one slot in the unformed section; and
at least one protrusion extending from the unformed section forming a generally concave or convex cross-sectional shape in the sidewall.

4. The bearing of claim 1, wherein the bearing further comprises a projection.

5. The bearing of claim 1, wherein the protrusion comprises a rectilinear protrusion in a radial direction.

6. The bearing of claim 1, wherein the protrusion comprises an arcuate protrusion in a radial direction.

7. The bearing of claim 1, wherein the slot runs at least 50% of an axial length of the sidewall.

8. The bearing of claim 1, wherein the at least one slot comprises a length, L_{S}, and a width, W_{S}, and L_{S}:W_{S}≥2:1.

9. The bearing of claim 1, wherein the at least one protrusion extends radially outward from the sidewall.

10. The bearing of claim 1, wherein the at least one protrusion extends radially inward from the sidewall.

11. The bearing of claim 1, wherein the at least one protrusion forms a concave cross-sectional shape in the sidewall.

12. The bearing of claim 2, wherein the at least one protrusion forms a convex cross-sectional shape in the sidewall.

13. The bearing of claim 1, wherein the protrusion comprises a plurality of protrusions.

14. The bearing of claim 1, wherein the slot comprises a plurality of slots.

15. The bearing of claim 14, wherein the protrusions and slots are ordered alternatively around the sidewall.

16. The bearing of claim 14, wherein at least two protrusions or at least two slots are ordered sequentially around the sidewall.

17. The bearing of claim 1, wherein the bearing comprises an annular cross-sectional shape perpendicular to a central axis.

18. The bearing of claim 1, wherein the low friction layer comprises asperities comprising a plurality of apexes and nadirs, wherein the low friction layer has a root mean square gradient of less than 0.064, wherein the low friction layer induces formation of a film when engaged in a rotational interface w/ another component.

19. The bearing of claim 1, wherein the sidewall comprises an axial gap.

20. The bearing of claim 1, wherein the bearing further comprises at least one radial flange.
